(19) United States
(12) Patent Application Publication
(10) Pub. No.: US 2008/0304640 A1
(43) Pub. Date: Dec. 11, 2008

(54) TELEPHONE WITH RFID MONITORING AND CONTROL

(76) Inventor: Gordon Reilly, Saint Marys, GA (US)

Correspondence Address: MEHRMAN LAW OFFICE, P.C., P.O. Box 420797, ATLANTA, GA, 30342, US

(21) Appl. No.: 11/759,382

(22) Filed: Jun. 7, 2007

(51) Int. Cl. H04M 15/00

(52) U.S. Cl. 379/111

(57) ABSTRACT

An RFID telephone system that includes an RFID reader that reads RFID tags contained on wristbands worn by inmates. The system uses the RFID reader to monitor and control telephone calls conducted over the inmate telephone, including the creation of records associating each telephone call with a particular inmate identifier read from an RFID tag in connection with the telephone call. The RFID reader obtains an authorized inmate identifier read from an RFID tag placed in close proximity to the inmate telephone and enters the inmate identifier in a record that associated that inmate identifier with the telephone call. The RFID telephone system inserts the personal identifiers read from RFID tags into the CLID field of a calling directory number service, and may also include a local call monitoring system that stores the personal identifiers in association with audio recordings of the telephone calls.

### TECHNICAL FIELD

The present invention is generally related to telephone monitoring systems and, more particularly, to a telephone with RFID monitoring and control suitable for use by inmates in correctional facilities or others requiring automatic identity monitoring of telephone usage.

### BACKGROUND OF THE INVENTION

Correctional facilities, such as jails, prisons, juvenile detention centers and the like often provide telephones for use by inmates, which are referred to as “inmate telephones.” Inmates in these facilities have typically been charged or convicted of some type of criminal conduct that has led to their incarceration. All too often, inmates may attempt to further their criminal endeavors using the inmate telephone provided by the correctional facility. For this reason, inmates are usually advised that communications conducted over inmate telephones may be recorded, and the communications are, in fact, typically recorded. Nevertheless, a certain percentage of inmates will still divulge incriminating or other information that is of interest to law enforcement authorities during communications conducted over inmate telephones. The conversations recorded on inmate telephones can, therefore, become important evidence in criminal proceedings.

Conventional inmate telephones and associated telephone call recording systems have a drawback, however, in positively associating a particular recorded conversation with the particular inmate who engaged in the conversation. This can be an important limitation when a recorded conversation divulged incriminating information that law enforcement would like to enter into evidence in a legal proceeding. Although it may be possible to use voice analysis or circumstances discussed during the conversation to prove that a particular inmate engaged in a particular recorded conversation, a lack of this type of supporting evidence can render the recorded conversation inadmissible in a court of law. Even when the recording can be rendered admissible, the requirement of producing this type of supporting evidence to make the recorded telephone call admissible is costly and time consuming.

As a result, there is a continuing need for an improved inmate telephone system and, in particular, a need for an inmate telephone system that facilitates the creation of evidence associating particular inmates with the telephone calls that they engage in using inmate telephones.

### SUMMARY OF THE INVENTION

The present invention meets the needs described above in an inmate telephone system that includes an RFID reader that reads RFID tags contained on wristbands worn by inmates. The system uses the RFID reader to monitor and control telephone calls conducted over the inmate telephone, including the creation of records associating each telephone call with a particular inmate identifier read from an RFID tag in connection with the telephone call. The RFID reader obtains an authorized inmate identifier read from an RFID tag placed in close proximity to the inmate telephone and enters the inmate identifier in a record that associated that inmate identifier with the telephone call. The invention may be implemented within a telephone system that inserts personal identifiers read from RFID tags into the caller ID field of a calling directory number service, and typically involves a telecommunications switch that creates call detail records that include the personal identifiers received through the caller ID fields.

Generally described, the inmate telephone system includes an RFID tag storing a personal identifier assigned to a person, such as an inmate at a detention facility, and an attachment device, such as a wrist band, for affixing the RFID tag to be carried by the person. A computer memory stores a record associating the personal identifier with the person to whom the personal identifier has been assigned. The inmates at the detention facility are typically allowed access to a telephone located in a common area, such that different inmates can make telephone ails over the same telephone. An RFID reader reads the personal identifier from an inmate's RFID tag when the RFID tag is located in close proximity to the telephone, and a controller associates the personal identifier read by the RFID reader with a telephone call conducted over the telephone. The system may also include an RFID writer operable for writing the personal identifier to the RFID tag, which may be incorporated into a wristband or other body-worn attachment device.

The controller may also maintain the telephone in an inoperable condition prior to receiving a valid personal identifier read by the RFID reader, activate the RFID reader in response to detecting an off-hook condition of the telephone, determine whether a valid personal identifier has been read by the RFID reader after the off-hook condition, and activate the telephone the telephone call upon determining that a valid personal identifier has been read by the RFID reader after the off-hook condition. The controller may then periodically activate the RFID reader during the telephone call, and disconnect the telephone call upon determining that a valid personal identifier has not been read by the RFID reader during the telephone call.

In one embodiment, the controller is operable for associating the personal identifier with the telephone call by inserting the personal identifier into a caller ID field defined by a calling number delivery feature associated with telecommunications service provided to the telephone prior to connection of the telephone call. In this case, the telecommunications service provided to the telephone includes the creation of a call detail record storing the personal identifier entered into the caller ID field in connection with parameters associated with the telephone call including a date, time and destination directory number associated with the telephone call. In another embodiment, the system also includes a telephone call monitoring system operable for recording the telephone call and storing the personal identifier in connection with the recording of the telephone call. In addition, these embodiments may be combined to create a system for creating multiple records associating the personal identifier with the telephone call.

Other features and advantages of the present invention will become apparent to one with skill in the art upon examination of the following drawings and detailed description. It is intended that all such additional features and advantages be included herein within the scope of the present invention.

### BRIEF DESCRIPTION OF THE DRAWINGS

FIG. 1 is a front view of a telephone with RFID monitoring and control and an associated wristband carrying an RFID tag.

FIG. 2 is a functional block diagram of a RFID telephone system.

FIG. 3 is a functional block diagram of a RFID telephone system utilizing a private branch exchange.

FIG. 4 is a conceptual illustration of a call detail record and a call monitoring system report for an RFID telephone system.

FIG. 5 is a logic flow diagram for initiating a telephone call in an RFID telephone system.

FIG. 6 is a logic flow diagram for monitoring a telephone call in an RFID telephone system.

### DETAILED DESCRIPTION OF THE EXEMPLARY EMBODIMENTS

The present invention may be embodied in an inmate RFID telephone system suitable for use in a jail, prison, rehabilitation facility or any other location where it is useful to positively associate particular persons with telephone calls that they conduct. The RFID telephone system typically reads body-worn RFID tags, such as RFID tags located on wristbands carried by the persons who are authorized to use the telephone when the tags come sufficiently near the telephone. In particular, the RFID tag can be worn on the arm that the person The RFID telephone is preferably inoperative unless and until a valid RFID tag has been read by an RFID tag reader locate in or associated with the telephone, so that the telephone only becomes available for use only after a valid RFID tag has been read by the RFID reader. The RFID telephone may also periodically pole for a valid RFID tag during an ongoing telephone call, and disconnect the ongoing telephone call if a valid RFID tag is not periodically read during the course of the telephone call, on so that the telephone can only be used while a valid RFID tag remains located within the reading range of the RFID reader.

The RFID telephone system may be implemented with individual telephones or in connection with a multi-telephone system, such as a private branch exchange (PBX). The process for associating individual telephone calls with personal identifiers read from RFID tags typically involves the insertion of the personal identifiers read from an RFID tag into the caller identification (CLID) field associated with a calling number delivery feature provided by the applicable telecommunications service. This causes the personal identifier to be delivered to the originating telephone switch, where it is entered into a call detail record for the associated telephone call. The personal identifier read from an RFID tag may also be transmitted to a local telephone call monitoring system that creates an audio recording of the telephone call to create a second identification record. In this manner, the RFID telephone system creates highly reliable evidence associating the inmates with the telephone calls that they conduct using the RFID telephone system.

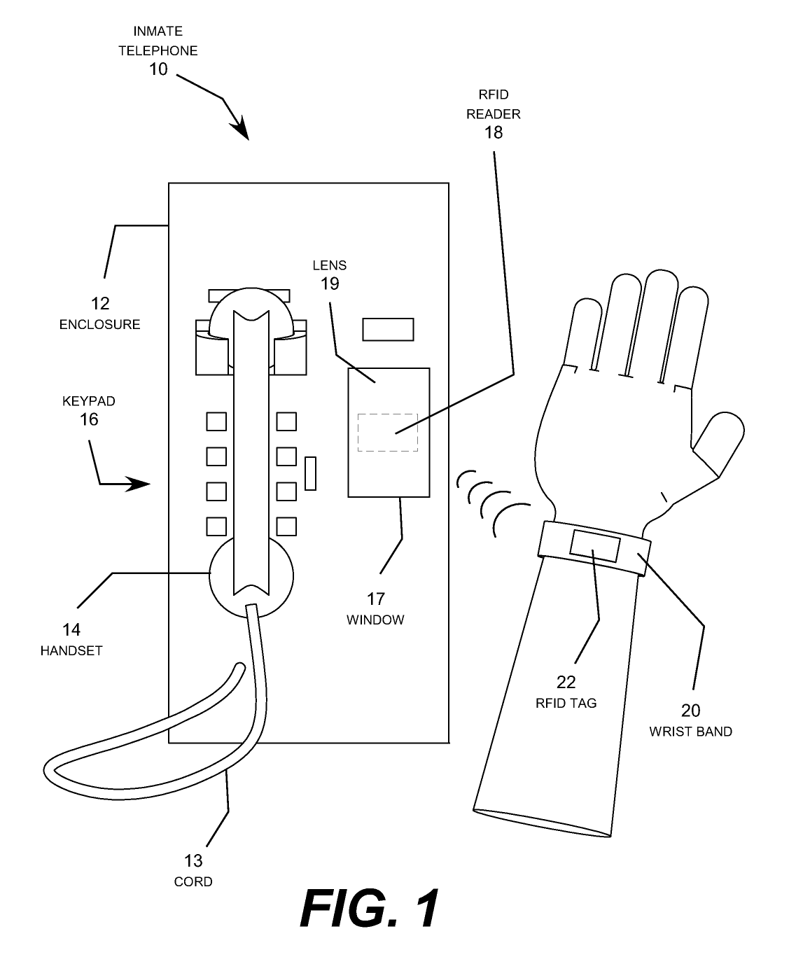

Turning now to the figures, in which like numerals refer to like elements throughout the figures, a specific embodiment of the invention will be described for illustrative purposes. FIG. 1 is a functional block diagram a front view of an inmate telephone 10 with RFID monitoring and control. The inmate telephone 10 typically includes a rugged wall-mounted enclosure 12, a heavy-duty handset 14 and cord 13 attaching the handset to the enclosure, and a heavy-duty keypad 16, which may be of similar construction to those used in publicly available pay telephone booths. To implement the present invention, the inmate telephone 10 also includes an RFID reader 18 with its transceiver located behind a suitable window 17 that permits the reader to transmit and receive radiated signals. For example, the window 17 may be covered with a wide-angle dielectric lens 19 that focuses or spreads the signals radiated by the RFID reader such that the reader only reads RFID tags that are located within a predefined distance, such as the approximate distance that the cord 13 will allow the handset 14 to extend from the enclosure 12. That is, the lens 19 should have a sufficiently wide angle of coverage to allow the RFID reader 18 to read an RFID tag 22 carried by the arm used to hold the telephone handset 14 throughout the range of movement permitted by the cord 13. The RFID reader as controlled by the lens should also have a limited reading range so that the reader does not read tags that are significantly further from the lens than the range of movement permitted by the cord.

The RFID reader 18 may be deployed on a circuit board located within the enclosure, in which case it includes a suitable communication port (e.g., USB port) supported by the enclosure. Nevertheless, it should be appreciated that the RFID reader 18 could alternatively be implemented using an external RFID reader mounted to extend through a hole in the wall on which the telephone 10 is mounted and through a hole in the rear of the telephone enclosure 12, with its transceiver positioned near the window 19. In alternative embodiments, the RFID reader 18 could also be positioned in a location external to the inmate telephone 10, for example in an enclosure beside the telephone, behind a ceiling tile located above the telephone, under a table located under the telephone, or in any other suitable location.

Persons authorized to use the inmate telephone 10 are issued body-worn RFID tags, such as a wristband 20 carrying an RFID tag 22, as shown in FIG. 1. The RFID tag 20 stores a personal identifier assigned to the associated person. The personal identifier may be static, and a suitable record is maintained whenever the wristband 20 is checked out to a particular inmate. Alternatively, for additional security, a no-site RFID writer may be used to write a unique personal identifier assigned to a particular person using the wristband 20 whenever the wristband is checked out to a particular inmate. In either case, a suitable record is maintained associating specific persons authorized to use the inmate telephone 10 with the personal identifiers encoded on the body-worn RFID tags assigned to those persons.

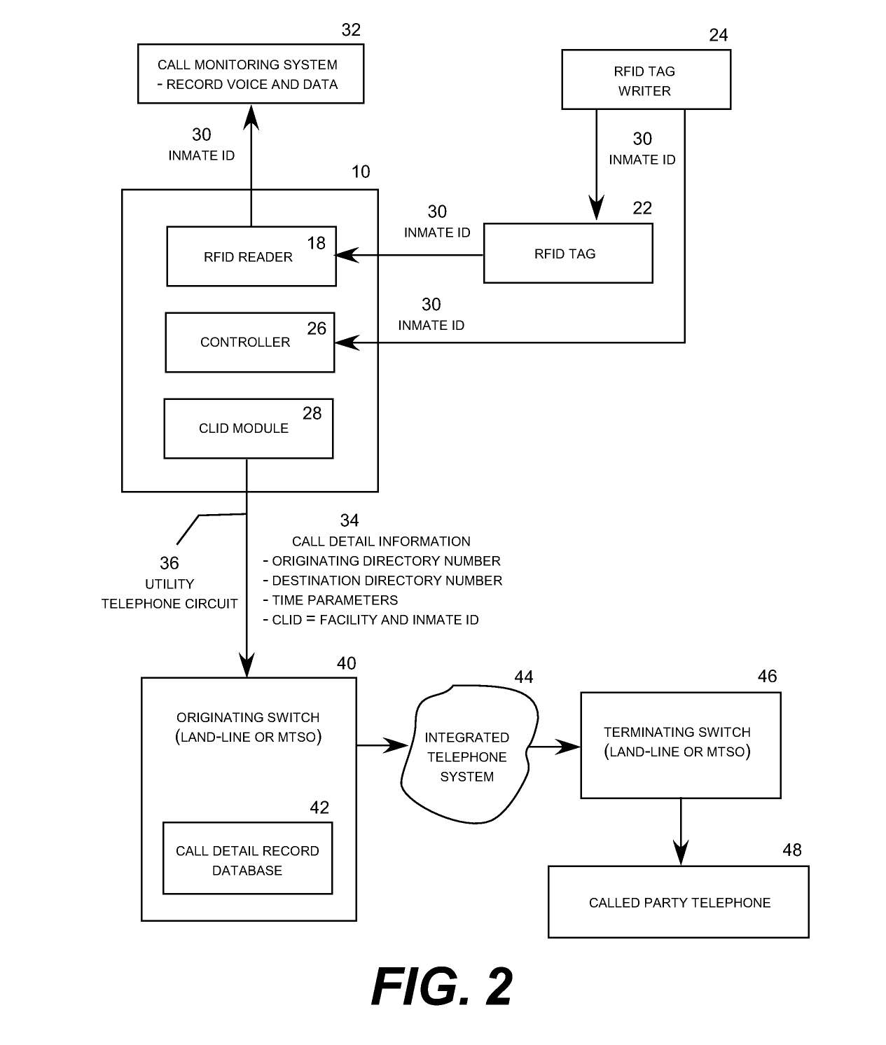

FIG. 2 is a functional block diagram of an RFID telephone system that includes the inmate telephone 10 described above. In this RFID telephone system, the inmate telephone 10 includes the RFID reader 18, a controller 26 and a CLID module 28 that is operative for writing information provided by the controller to the CLID field associated with the calling number delivery feature provided by the applicable telecommunications service subscribed to for the inmate telephone. The RFID tag 22 may contain a static inmate ID 30 or an RFID writer 24 may be used to write a unique inmate ID onto the RFID tag 22. In either case, an appropriate record is created associating the inmate ID with the inmate to whom it is assigned, and the wristband 20 is fastened around the wrist of that inmate. The RFID writer 24 also transmits the inmate ID 30 to the controller 26, where it is stored as a valid personal identifier. These provisions the inmate telephone 10 for use by the person assigned the inmate ID 30.

When the person assigned the inmate ID 30 desires use or the inmate telephone 10, they approach the telephone and lift the handset 14, preferably using the arm carrying the wristband 20. The resulting off-hook condition of the telephone 10 triggers the RFID reader 18 to pole for an RFID tag located with in its reading range. The reading range of the RFID reader 18, which may be controlled to some extent by the lens 19, is configured such that the RFID tag 22 will be within the reading range of the RFID reader 18 when the RFID tag 22 is located on the wristband 20 fastened around the arm of a person who has used that arm to lift the handset 14 into the off-hook condition. For example, the reading range of the RFID reader 18 may be configured such that it will only read RFID tags located approximately within the distance that the cord 13 allows the handset 14 to extend from the telephone enclosure 12.

Once the RFID reader 18 reads the inmate ID 30 from the RFID tag 22, the RFID reader provides the inmate ID the controller 26, where it is checked for validity. If the inmate ID 30 is valid, the controller 26 activates the telephone 10 for use (e.g., provides a dial tone) and provides the inmate ID to the CLID module 28, which writes the inmate ID to the CLID field associated with the calling number delivery feature provided by the applicable telecommunications service provided to the inmate telephone. Optionally, the controller 26 also provides the inmate ID 30 to a local call monitoring system 32 that stores the inmate ID in association with an audio recording and other parameters of the ensuing telephone call, such as the destination (dialed) directory number and the time and duration of the call.

Entering the inmate ID 30 in the CLID field causes the inmate ID to become part of the call detail information 34 transmitted over the utility telephone circuit 36 to the originating telecommunications switch 40, typically a utility-operated land-line signal switching point (SSP) or mobile telephone switching office (MTSO). The originating telecommunications switch 40, either internally or in concert with additional network components, stores a call detail record (CDR) for the telephone call a call detail record database. This causes the CDR, which is routinely created for billing and other telecommunication functions, to capture and store the inmate ID 30 in association with other parameters associated with the telephone call, typically including at least the originating directory number assigned to the telephone 10 (which is preferably included in the CLD field along with the inmate ID), the destination directory number dialed to place the telephone call, the time the call was originated, and the duration of the telephone call. The originating telecommunications switch 40 further routes the telephone call in a conventional manner, typically over the integrated telephone system 44, to a terminating switch 46, and to the called party telephone 48. The term “integrated telephone system” indicates that the telephone call could be routed over the land-line, mobile, inter-exchange, voice-over-IP, satellites, private branch exchange, or any other suitable telecommunications media integrated in any manner that completes the telephone call.

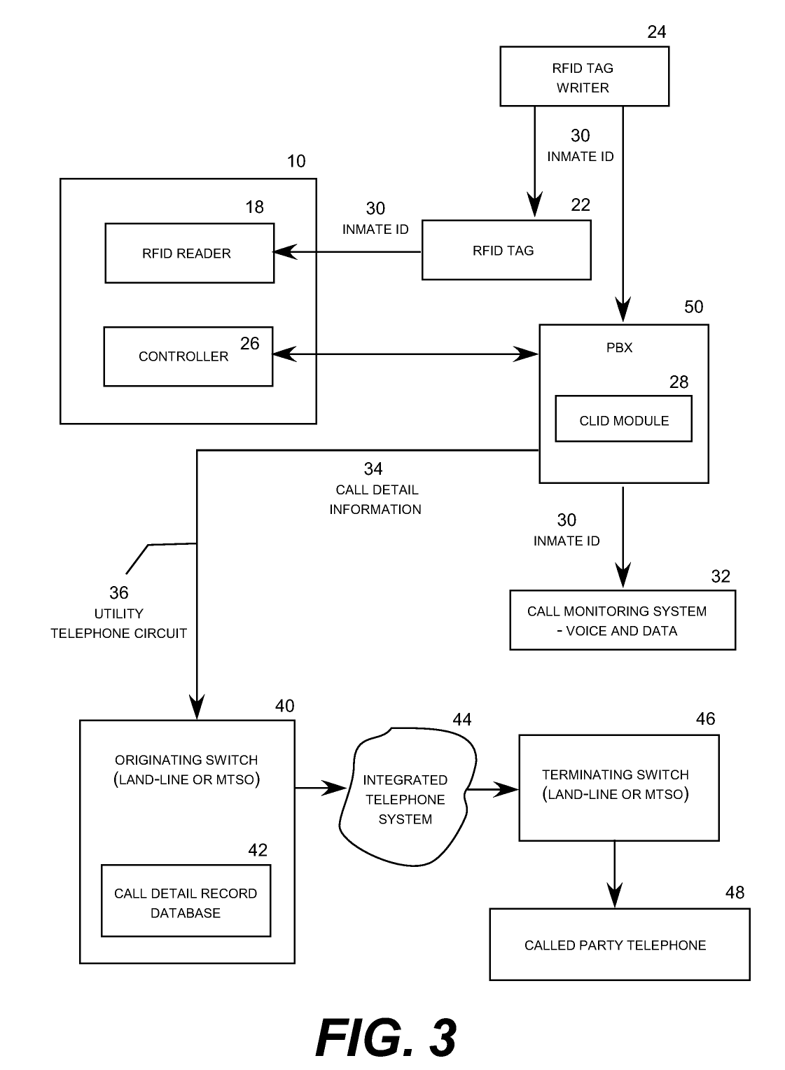

FIG. 3 is a functional block diagram of an RFID telephone system utilizing a private branch exchange (PBX) 50. This RFID telephone system is similar to the system described above with reference to FIG. 2, except that this embodiment includes the PBX 50, which typically interfaces a number of digital telephones with a bulk telephone circuit 36, such as a T-1 line. This type of system can be readily configured to operate as described above with the PBX 50 providing the functionality of the CLID module 28. Of course, the PBX could also provide some or all of the functionality described for the controller 26 and the call monitoring system 32, and it will be appreciated that the division of functions in a telephone system between the PBX, the individual telephones, and external components such as call monitoring equipment is a matter of design choice.

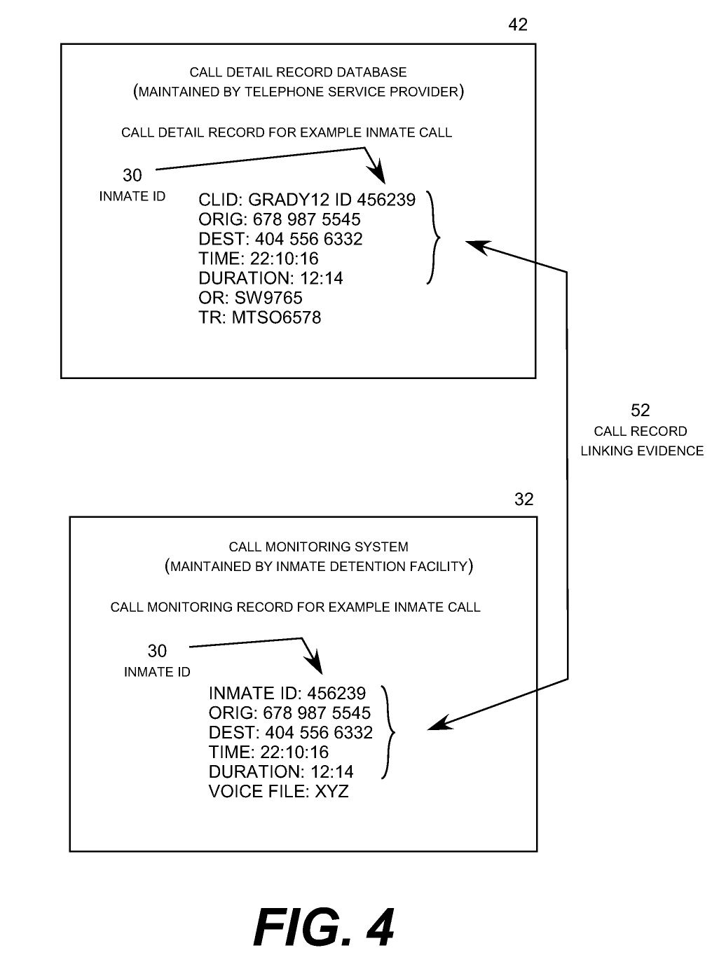

FIG. 4 is a conceptual illustration of an example CDR in the CDR database 42 and a call monitoring system report created by the local call monitoring system 32 for the RFID telephone system. As shown in FIG. 4, the inmate ID 30 is recorded in the CDR database 42 as part of the CDR for the applicable telephone call created by the originating switch 40 along with the other call parameters routinely stored in the CDR, such as the originating telephone number, the destination telephone number, the time of the call, the duration of the call, the identity of the originating switch, the identity of the terminating switch, and so forth. The inmate ID 30 is also recorded in the call monitoring record created by the local call monitoring system 32 along with additional information pertaining to the call, such as the originating telephone number, the destination telephone number, the time of the call, the duration of the call, and an audio recording of the telephone call. These two separate records, create by separate systems under the control of different parties, form highly reliable linking evidence 52 associating the particular inmate assigned the inmate ID 30 with the subject telephone call. This type of linking evidence can then be used in a court of law, if needed, for example if the inmate makes incriminating statements during the telephone call that require entry into evidence in a criminal prosecution.

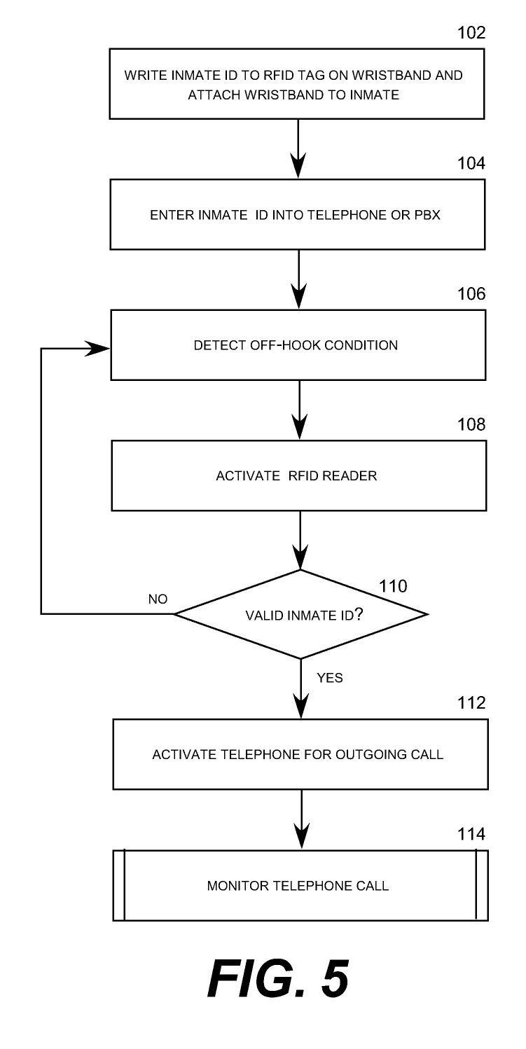

FIG. 5 is a logic flow diagram for call record process 100 for monitoring sand controlling a telephone call in an RFID telephone system. In step 102, an inmate ID is assigned to an inmate and written to an RFID tag on a suitable body-worn item or garment, such as a wristband. The wristband is than attached around the wrist of the associated inmate. Alternatively, an RFID tag having a static may be assigned to the inmate. In either case, a suitable record is created associating the inmate with the assigned inmate ID, for example in a paper log book, computer database, or both. Step 102 is followed by step 104, in which the inmate ID is entered into the RFID telephone system (e.g., RFID telephone or PBX, as applicable) as a valid inmate ID. Step 104 is followed by step 106, in which the RFID telephone system detects an off-hook condition, for this example when the person wearing the RFID wristband picks up the telephone handset using the arm to which the wristband is attached. In response to the off-hook condition, in step 108 the RFID reader is activated to pole for an RFID tag within its readable area, which is typically set to correspond approximately with the length of the cord attaching the handset to the telephone enclosure. Step 108 is followed by step 110, in which the RFID telephone system determines whether the RFID reader has read a valid inmate ID.

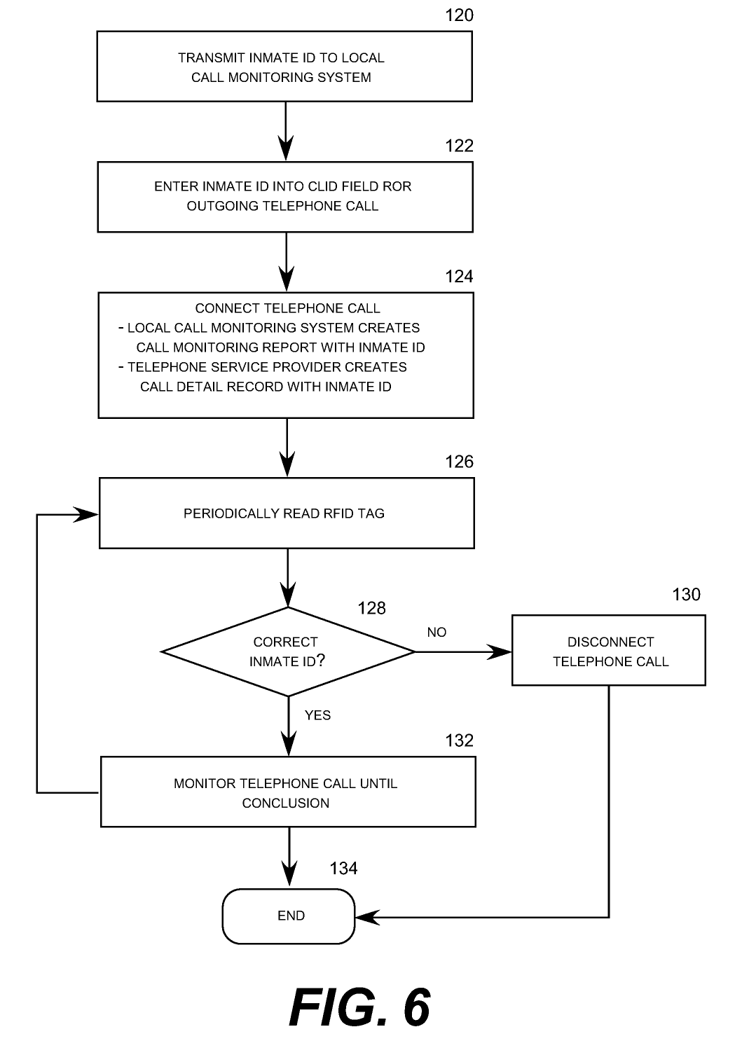

If the RFID reader has not read a valid inmate ID, the “NO” branch is followed from step 110 to step 106, in which the RFID telephone system remains inactive for telephone calls and waits to detect a subsequent off-hook condition. That is, the telephone circuit of the RFID telephone system remains inactive until the system receives and validates a valid inmate ID read by the RFID reader. If, on the other hand, the RFID reader has read a valid inmate ID, the “YES” branch is followed from step 110 to step 112, in which the RFID telephone system actives for a telephone call, which typically involves providing appropriate voltage and dial tone to a conventional land-line telephone. However, the RFID telephone system could alternatively activate in whatever matter is appropriate for the particular type of telephone service, such as activating the “send” function for a mobile telephone, connecting the telephone to a satellite system for a satellite telephone, connecting the telephone to an Internet port for a voice-over-IP telephone, and so forth. Step 112 is followed by routine 114, in which the RFID telephone system monitors the telephone call, which is described in greater detail below with reference to FIG. 6.

FIG. 6 is a logic flow diagram for routine 114, in which the RFID telephone system monitors and controls the telephone call. In step 120, the RFID telephone system sends the inmate ID associated with the telephone call to a local call monitoring system, which typically creates an audio recording of the telephone call and stores the inmate ID in association with the audio recording and other parameters of the telephone call, such as the destination (dialed) telephone number, an identification of the originating telephone, and the time and duration of the telephone call. Step 120 is followed by routine 122, in which the RFID telephone system enters the inmate ID into the CLID field associated with a calling number delivery feature provided by the applicable telecommunications service. Step 122 is followed by routing 124, in which the telephone call is connected and telephone call monitoring reports containing the inmate ID are created by the local call monitoring system and the telephone service provider. Specifically, the local call monitoring system stores the inmate ID in association with an audio recording and other parameters associated with the telephone call. Step 122 is followed by routing 124, in which the RFID telephone system periodically activates the RFID reader, for example every ten seconds, to ascertain the presence of RFID tags within its reading range. Step 124 is followed by routing 126, in which the RFID telephone system determines whether the correct RFID tag (i.e., the RFID tag present at the time the telephone was activated for the present telephone call) was read by the RFID reader. If the correct RFID tag was not read, the “NO” branch is followed to step 130, in which the RFID telephone system disconnects the telephone call. If the correct RFID tag was not read, the “YES” branch is followed to step 132, in which the RFID telephone system continues to monitor the telephone call until its conclusion, which may involve periodically looping back to step 126. Steps 130 and 132 are followed by the “End” step 134.

It should be appreciated that this particular operating routing is merely illustrative and may be varied as a matter of design choice in implementing the RFID telephone system. In addition, many other features of the inmate telephone system will become apparent to those skilled in the art once the principles of the invention, as described above, are understood.

In view of the foregoing, it will be appreciated that present invention provides significant improvements in inmate telephone systems. It should be understood that the foregoing relates only to the exemplary embodiments of the present invention, and that numerous changes may be made therein without departing from the spirit and scope of the invention as defined by the following claims.

The invention claimed is:

1. A telephone system for associating persons with telephone calls, comprising:
an RFID tag storing a personal identifier assigned to a person;
an attachment device for affixing the RFID tag to be carried by the person;
a computer memory operable for storing a record associating the personal identifier with the person to whom the personal identifier has been assigned;
a telephone interconnected with a telecommunications network operable for conducting telephonic conversations;
an RFID reader operable for reading the personal identifier from the RFID tag when the RFID tag is located in close proximity to the telephone; and
a controller operable for associating the personal identifier read by the RFID reader with a telephone call conducted over the telephone.

2. The RFID telephone system of claim 1, wherein the controller is further operable for:
maintaining the telephone in an inoperable condition prior to receiving a valid personal identifier read by the RFID reader;
activating the RFID reader in response to detecting an off-hook condition of the telephone,
determining whether a valid personal identifier has been read by the RFID reader after the off-hook condition; and
activating the telephone the telephone call upon determining that a valid personal identifier has been read by the RFID reader after the off-hook condition.

3. The RFID telephone system of claim 4, wherein the controller is further operable for periodically activating the RFID reader during the telephone call, and disconnecting the telephone call upon determining that a valid personal identifier has not been read by the RFID reader during the telephone call.

4. The RFID telephone system of claim 1, wherein the controller is operable for associating the personal identifier with the telephone call by inserting the personal identifier into a caller ID field defined by a calling number delivery feature associated with telecommunications service provided to the telephone prior to connection of the telephone call.

5. The RFID telephone system of claim 4, wherein the telecommunications service provided to the telephone comprises creation of a call detail record storing the personal identifier entered into the caller ID field in connection with parameters associated with the telephone call including a date, time and destination directory number associated with the telephone call.

6. The RFID telephone system of claim 1, further comprising a telephone call monitoring system operable for recording the telephone call and storing the personal identifier in connection with the recording of the telephone call.

7. The RFID telephone system of claim 1, configured for creating multiple records associating the personal identifier with the telephone call, wherein the controller is operable for the personal identifier into a caller ID field defined by a calling number delivery feature associated with telecommunications service provided to the telephone prior to connection of the telephone call, further comprising a telephone call monitoring system operable for recording the telephone call and storing the personal identifier in connection with the recording of the telephone call.

8. The RFID telephone system of claim 1, further comprising an RFID writer operable for writing the personal identifier to the RFID tag.

9. The RFID telephone system of claim 1, wherein the attachment device comprises a wristband.

10. A method for associating persons with telephone calls, comprising the steps of:
associating a personal identifier with a person;
writing the personal identifier to an RFID tag;
affixing the RFID tag to be carried by the person;
providing a telephone interconnected with a telecommunications network operable for conducting telephonic conversations;
providing an RFID reader operable for reading the personal identifier from the RFID tag when the RFID tag is located in close proximity to the telephone;
maintaining the telephone in an inoperable condition prior to receiving a valid personal identifier read by the RFID reader;
activating the RFID reader in response to detecting an off-hook condition of the telephone, reading the personal identifier personal identifier from the RFID tag;
verifying that the personal identifier is a valid personal identifier;
activating the telephone for use in response to determining that the personal identifier is a valid personal identifier;
connecting a telephone call through the telephone; and
associating the telephone call with the personal identifier.

11. The method of claim 10, further comprising the steps of periodically activating the RFID reader during the telephone call, and disconnecting the telephone call upon determining that a valid personal identifier has not been read by the RFID reader during the telephone call.

12. The method of claim 10, wherein the step of associating the telephone call with the personal identifier comprises the step of inserting the personal identifier into a caller ID field defined by a calling number delivery feature associated with telecommunications service provided to the telephone prior to connection of the telephone call.

13. The method of claim 12, further comprising the step of creating a call detail record storing the personal identifier entered into the caller ID field in connection with parameters associated with the telephone call including a date, time and destination directory number.

14. The method of claim 10, further comprising the steps of recording the telephone call and storing the personal identifier in connection with the recording of the associated telephone call.

15. The method of claim 10, wherein the step of affixing the RFID tag to be carried by the person comprises the step of affixing a wristband carrying the RFID tag around a wrist of the person.

16. A system for associating persons with telephone calls, comprising:
a telecommunications switch operative for providing telecommunications services including connecting telephone calls, receiving caller ID designations in connection with the telephone calls, and creating call detail records associated with the telephone calls comprising the caller ID designations and parameters associated with the telephone calls including dates, times and destination directory numbers associated with the telephone calls;
a telephone operative for originating telephone calls through the telecommunications switch and transmitting caller ID designations to the switch in association with the telephone calls by including the caller ID designations in a caller ID field defined by the telecommunications service;
an RFID tag comprising a personal identifier assigned to a person;
an RFID reader operable for reading the personal identifier from the RFID tag when the RFID tag is located in close proximity to the telephone; and
a controller operative for inserting the personal identifier into the caller ID field and activating the telephone for a telephone call so that the personal identifier becomes recorded as the caller ID designation in the call detail record created by the telecommunications switch for the telephone call.

17. The system of claim 16, further comprising an RFID writer operable for writing the personal identifier to the RFID tag.

18. The system of claim 16, further comprising a telephone call monitoring system operable for recording the telephone call and storing the personal identifier in association with the recording of the telephone call.

19. The system of claim 16, wherein the controller is further operable for:
maintaining the telephone in an inoperable condition prior to receiving a valid personal identifier read by the RFID reader;
activating the RFID reader in response to detecting an off-hook condition of the telephone, and
determining whether a valid personal identifier has been read by the RFID reader after the off-hook condition; and
activating the telephone the telephone call upon determining that a valid personal identifier has been read by the RFID reader after the off-hook condition.

20. The system of claim 16, further comprising an attachment device for affixing the RFID tag to be carried by the person.
